(19) United States
(12) Patent Application Publication
(10) Pub. No.: US 2004/0181949 A1
(43) Pub. Date: Sep. 23, 2004

(54) Wet shaving cartridge with provision of shaving aid

(75) Inventors: David C. Coffin, Hamden, CT (US); Randy Nicolosi, Shelton, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/782,568

(22) Filed: Feb. 19, 2004

Related U.S. Application Data
(60) Provisional application No. 60/448,265, filed on Feb. 19, 2003.

(51) Int. Cl. B26B 21/00

(52) U.S. Cl. 30/346.57; 30/50

(57) ABSTRACT

In a razor cartridge, a housing is provided having first and second razor blade assemblies positioned therein. The first and second razor blade assemblies each include at least one razor blade and an at least partially exposed cutting edge. The razor blades are positioned in the first and second blade assemblies to allow hair to be cut from a user's skin when the razor cartridge is drawn thereover in either of two generally opposite cutting directions. At least one shaving aid outlet is defined by the razor cartridge and positioned between the first and second razor blade assemblies to allow the shaving aid to be dispensed therethrough.

### BACKGROUND OF THE INVENTION

During a wet shaving experience, it is not uncommon for a user's skin to be irritated as a result of the cutting edges of the razor blades being drawn across the skin. This problem is exacerbated when the shaving implement, as is common today, includes multiple razor blades. In an effort to alleviate shaving discomfort, strips of material impregnated with small amounts of shaving aid, referred to by those skilled in the art to which the present invention pertains as “comfort strips”, have been incorporated into razor cartridges. As the razor is drawn across a user's skin, the shaving aid leeches out of the comfort strip onto the skin. However, there are occasions when it would be desirable to be able to apply larger amounts of shaving aid to the skin, or to be able to vary the types of shaving aid applied.

This is particularly true when using wet shave razors configured to cut hair bidirectionally. Generally, razors configured in this manner incorporate two or more blades, the cutting edges of which are in opposition to one another. Wet shave razors configured in this manner would be able to cut hair by being drawn over a user's skin in either of two generally opposite directions. Because as one or more blades are drawn over the user's skin in a cutting direction, other blades are being dragged over the skin in a non-cutting direction, the potential for increased drag, blade chatter, and discomfort is increased. The ability to apply a shaving aid, during a shaving operation, to increase lubricity would reduce or perhaps eliminate any discomfort.

Based on the foregoing, it is the general object of the present invention to provide a shaving implement that improves upon, or overcomes, the above-described problems associated with the prior art.

### FIELD OF THE INVENTION

The present invention relates generally to wet shaving razor blade devices, and more particularly to a wet shaving cartridge capable of exuding a liquid or gel shaving aid.

### SUMMARY OF THE INVENTION

In a preferred aspect of the present invention, a blade cartridge for a wet shaving device capable of exuding a liquid shaving aid comprises a housing defining first and second cavities for receiving respective blade assemblies to be mounted in the housing. A centrally located support member included in the housing divides the first and second cavities. A channel is disposed in the support member along the topside of the housing, and at least one conduit extends from the channel through the support member for communication with a shaving aid reservoir.

Preferably, the shaving aid reservoir is housed within the handle for the shaving device, and permits the user to pump a liquid or gel shaving aid to the channel where it can be applied to the skin of the user during a shaving operation. Each of the blade cartridges preferably include a plurality of blades defining a cutting plane and providing a “closer” shave than otherwise possible with a single blade. The channel is provided with a sufficient amount of shaving aid to be able to apply the shaving aid to the user's skin as it interacts with the cutting plane.

The shaving aid may be in the form of a lubricant, whisker softener, razor cleaner, medicinal agent, cosmetic agent or a combination of two or more of the above. Preferably, the shaving aid is located adjacent to the cutting edges of the blades. Upon wetting and stroking of the cutting edges over the skin, the shaving aid is applied directly to the skin, preferably in advance of the cutting stroke. In a shaving device- capable of bi-directional shaving—i.e., with two blade assemblies having blades facing each other—the shaving aid cooperates with both blade assemblies to improve the overall efficiency of the shaving process. As so designed, the shaving device can be used in both the forward and return stroke directions, and further, the shaving device can be used without removing and reapplying the razor to the skin between strokes. The shaving aid provides the advantage of aiding the skin after a forward cutting stroke, while simultaneously preparing the skin for the return stroke.

In another aspect of the present invention, the housing of the blade cartridge defines a plurality of first drainage channels as part of the first and second cavities extending between the guide ends of the blade cartridge, and a plurality of second drainage channels as part of the first and second cavities extending between longitudinal ends of the blade cartridge in a direction generally perpendicular to that of the first drainage channels to facilitate flushing of debris, including excess shaving aid, that has settled within the cavities.

### BRIEF DESCRIPTION OF THE DRAWINGS

FIG. 1 is a top perspective view of a blade cartridge including two blade assemblies in opposing relationship with one another.

FIG. 2 is a bottom perspective view of the blade cartridge of FIG. 1 with the blade assemblies removed.

FIG. 3 is a cross-sectional view of the blade cartridge of FIG. 1 taken along the line A-A in FIG. 1.

### DETAILED DESCRIPTION OF THE PREFERRED EMBODIMENT

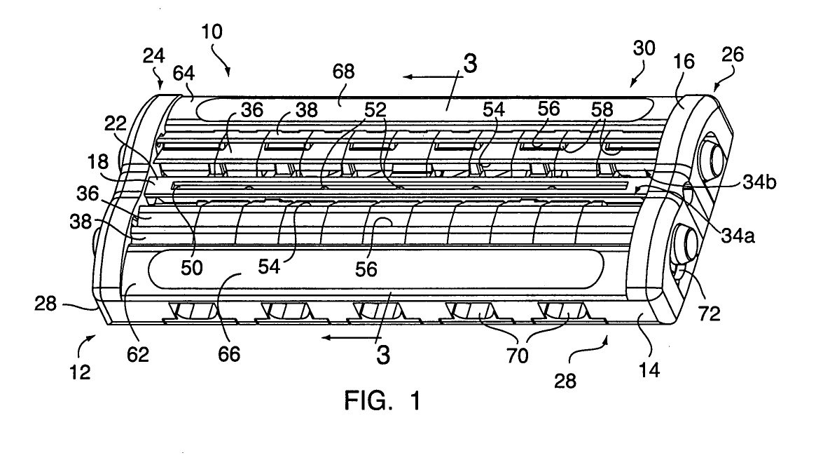

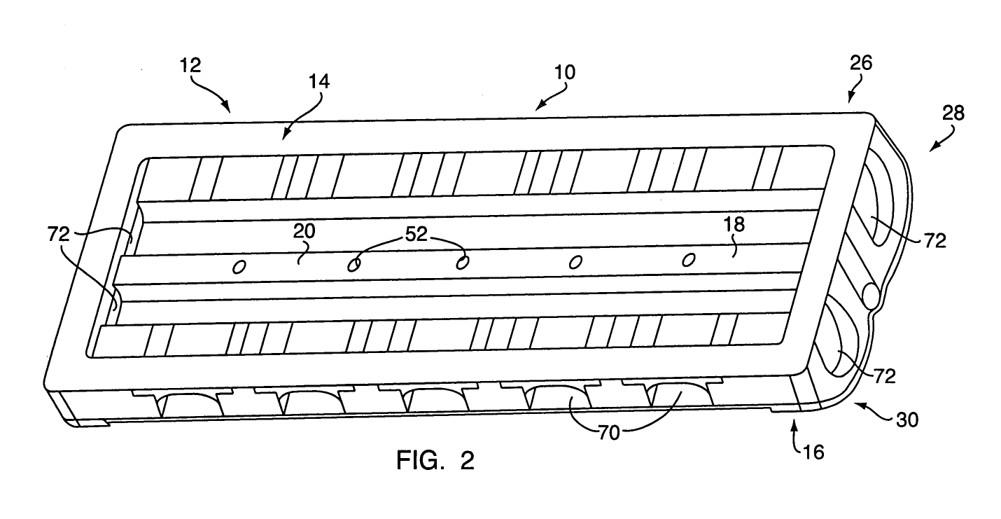

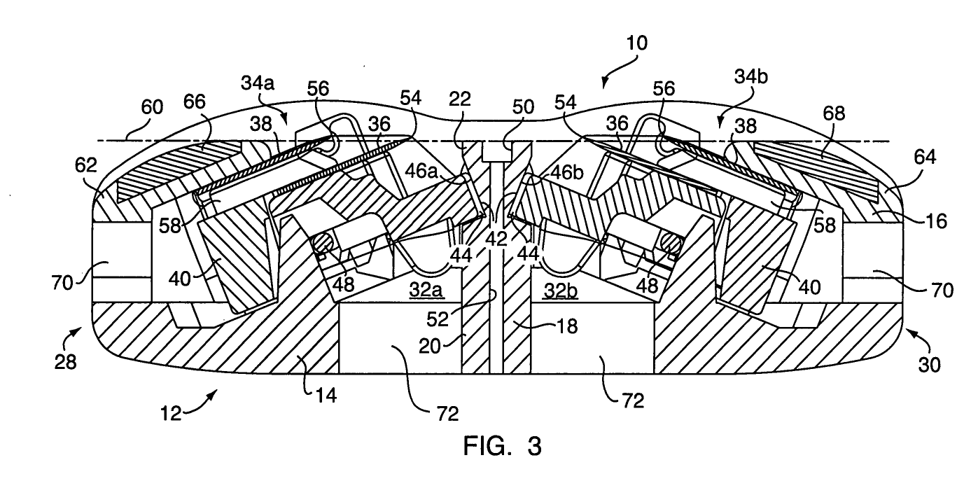

With reference to FIGS. 1 and 2, a blade cartridge embodying the present invention is designated generally by reference numeral 10. The blade cartridge 10 comprises a housing 12 preferably including a lower housing member 14 and an upper housing member 16. A centrally located support member 18 extends within the housing 12 and connects the lower housing member 14 to the upper housing member 16. The support member 18 may be comprised of a lower portion 20 and an upper portion 22 respectively associated with the lower housing member 14 and the upper housing member 16, and combining to form the support member 18, as seen in FIG. 3.

The housing 12 is shown in FIG. 1 as having a generally rectangular shape, but may be other shapes, such as oval or round, without departing from the scope of the present invention. As shown, the housing 12 has respective first and second longitudinal ends 24 and 26, as well as respective first and second lateral sides 28 and 30. The support member 18 typically extends along the housing 12 from the first longitudinal end 24 to the second longitudinal end 26, and is centrally located between the first and second lateral sides 28 and 30.

The lower housing member 14 and the upper housing member 16 cooperate to define a first cavity 32a and a second cavity 32b, as more clearly seen in FIG. 3, positioned on opposed sides of the support member 18. A first blade assembly 34a and a second blade assembly 34b are generally resiliently mounted within the first and second cavities 32a and 32b, respectively. The first and second blade assemblies 34a and 34b have generally the same shape, and are preferably identical to each other. For example, each blade assembly includes a first blade 36 and a second blade 38 mounted on a carrier 40. Further, the first and second blade assemblies 34a and 34b are preferably symmetrically positioned within the respective first and second cavities 32a and 32b—i.e., facing each other in mirrored relationship. This arrangement of the blade assemblies 34a and 34b permits bi-directional shaving (i.e., shaving in both forward and return stroke directions). Although each blade assembly is shown as having two blades, it should be understood that the blade assemblies could have any practical number of blades, such as, for example, one, two, three, four or five blades, without departing from the scope of the present invention.

Each of the first and second blade assemblies 34a and 34b preferably further include front abutment surfaces 42 projecting outwardly from a front, lower edge 44 to limit movement of the blade assembly within the housing 12. The support member 18, and preferably the upper portion 22 thereof, is provided with first and second forward stop surfaces 46a and 46b for respectively engaging the front abutment surfaces 42 of the first and second blade assemblies 34a and 34b to locate the blades 36 and 38 for shaving. Each blade assembly 34a and 34b is provided with a resilient member (shown in cross-section at 48) on its underside. The resilient member 48 is a safety feature which flexes and thereby permits a blade assembly to move generally rearwardly into the housing 12 independently of the other blade assembly when an excessive shaving force is exerted on the blades 36 and 38. Resilient member 48 further provides a restoring force to the associated blade assembly to return the blade assembly to its proper position in relation to the housing 12 when the excessive shaving force is removed from the blades.

As shown in FIG. 1, the support member 18 further includes a channel 50 disposed along the longitudinal length thereof. At least one conduit 52 extends from the channel 50 through the support member 18 to the underside of the housing 12. Preferably, as shown, a plurality of conduits 52 are provided along the length of the channel 50 so as to evenly distribute a shaving aid such as a gel to the channel 50 for application to the skin surface of the user during shaving. In operation, the conduits 52 communicate with a source of such shaving aid, such as a fluid reservoir housed within the razor handle to provide a liquid or gel shaving aid to the channel 50. The reservoir preferably permits the user to pump shaving aid through the conduits 52 and into the channel 50, for example, with a pumping mechanism communicating with the reservoir and located in or on the razor handle. From the channel 50, the shaving aid may be applied to the skin of the user during a shaving operation. The diameters of the conduits 52 and the depth and width of the channel 50 may be varied. Generally, smaller diameters for the conduits 52 facilitate control of the supply of shaving aid to the channel 50.

The configuration of the shaving aid, its place of application to the support member 18, the manner of attachment and /or other means and methods of incorporation may vary as known to fit particular requirements. The embodiment shown in FIGS. 1-3 and discussed herein is provided for illustration, and alternative designs for the shaving aid are permitted. For example, the shaving aid need not be a liquid or gel, and instead may be a solid but water-soluble medium. Additionally, the shaving aid may be embedded or dispersed onto the support member 18, or be outwardly attached thereto. As discussed below, additional shaving aid strips may be provided on other portions of the blade cartridge 10.

Exemplary materials constituting shaving aid may comprise one or various combinations of the following:

A lubricating agent for reducing the frictional forces between the shaving device and the skin—e.g., a micro-encapsulated silicone oil.

An agent which reduces the drag between the shaving device and the user's skin—e.g., a polyethylene oxide, a non-ionic polyacrylamide, and/or a natural polysaccharide derived from plant materials such as guar gum.

An agent which modifies the chemical structure of the hair to allow the blades to pass through the hair very easily—e.g., a depilatory agent.

A cleaning agent which allows the whisker and skin debris to be washed more easily from the shaving device during shaving—e.g., a silcon polyethylene oxide block copolymer and detergent such as sodium larnyl sulphate.

A medicinal agent for killing bacteria, or repairing skin damage and abrasions.

A cosmetic agent for softening, smoothing, conditioning or improving the skin.

A blood coagulant for the suppression of bleeding that occurs from nicks and cuts.

Referring to the first and second blade assemblies 34a and 34b shown in FIGS. 1 and 3, the first and second blades 36 and 38 on each blade assembly have respective cutting edges 54 and 56 that are generally parallel to each other. As mounted on the carrier 40, the first and second blades 36 and 38 are separated from one another by one or a plurality of spacers 58 interposed between and spaced along the length of the blades 36 and 38. As best shown in FIG. 3, the first and second blade assemblies 34a and 34b are mounted within the respective first and second cavities 32a and 32b such that the cutting edges 54 and 56 of the first blade assembly 34a generally face the cutting edges 54 and 56 of the second blade assembly 34b. The planar surfaces of the blades 36 and 38 are also slightly inclined with respect to a shaving plane 60 or a plane of contact with the skin of the user. The cutting edges 54 and 56 of the blades in a relaxed position extend slightly beyond the shaving plane 60 a sufficient distance to expose the cutting edges 54 and 56 in order to cut hair from the user's skin without cutting or otherwise damaging the skin. Preferably, the channel 50 is filled with shaving aid up to at least the level of the shaving plane 60 so that the shaving aid can be applied to the skin during shaving. Because of the centrally located position of the channel 50, there is no interference with the cutting edges 54 and 56 of the first and second blades 36 and 38.

The support member 18 may also include an elastomeric member (not shown) projecting upwardly therefrom into the shaving plane 60 to aid skin stretching and improve shaving closeness. The elastomeric member would be positioned in addition to the channel 50, and aid in application of shaving aid to the stretched skin.

The upper housing member 16 may include first and second end caps 62 and 64 along the respective first and second lateral sides 28 and 30 for generally guarding the first and second blade assemblies 34a and 34b, respectively. The upper housing member 16 may also include first and second side shaving aids 66 and 68 positioned generally above first and second caps 62 and 64, respectively, for applying a shaving aid similar to that distributed through the channel 50. As so designed, the first and second side shaving aids 66 and 68 work with the centrally located shaving aid in the channel 50.

Preferably, the lower housing member 14 and the upper housing member 16 cooperate to define a plurality of first drainage channels 70 as part of the first and second cavities 32a and 32b. The first drainage channels 70 generally extend between the first lateral side 28 and the second lateral side 30 of the blade cartridge 10 in order to facilitate the flushing of debris that has settled within the cavities 32a and 32b. The first drainage channels 70 also facilitate the removal of overflow shaving aid from the channel 50, which can occur if too much shaving aid is pumped from the reservoir. The overflow shaving aid generally is pushed into the first and second cavities 32a and 32b through the spaces between the first and second blades 36 and 38. The lower housing member 14 preferably further defines a plurality of second drainage channels 72 generally extending between the first longitudinal end 24 and the second longitudinal end 26 of the blade cartridge 10 in a normal direction to that of the first drainage channels 70. The second drainage channels 72 act to further facilitate the flushing of debris from the cavities 32a and 32b, as well as overflow shaving aid from the channel 50.

The foregoing description of embodiments of the present invention has been presented for the purpose of illustration and description, and is not intended to be exhaustive or to limit the present invention to the form disclosed. As will be recognized by those skilled in the pertinent art to which the present invention pertains, numerous changes and modifications may be made to the above-described embodiments without departing from the broader aspects of the present invention.

What is claimed is:

1. A razor cartridge comprising:
a housing,
a first razor blade assembly positioned in said housing;
a second razor blade assembly positioned in said housing;
said first and said second razor blade assemblies each including at least one razor blade having an at least partially exposed cutting edge, said razor blades positioned in said first and second blade assemblies to allow hair to be cut from a user's skin when said razor cartridge is drawn thereover in either of two generally opposite cutting directions;
at least one shaving aid outlet defined by said razor cartridge and positioned between said first and second razor blade assemblies; and
means defining a flow path for directing a shaving aid to said shaving aid outlet.

2. A razor cartridge as defined by claim 1 further comprising a support member positioned between said first razor blade assembly and said second razor blade assembly, said shaving aid outlet being defined by said support member.

3. A razor cartridge as defined by claim 2 wherein said means defining a flow path includes a conduit defined by said support member and in fluid communication with said shaving aid outlet, said razor cartridge being configured to fluidly communicate with a shaving aid reservoir so that shaving aid from said reservoir can be introduced into said conduit.

4. A razor cartridge as defined by claim 1 wherein said support member defines a channel positioned between said first razor blade assembly and said second razor blade assembly, said shaving aid outlet being positioned to discharge said shaving aid into said channel.

5. A razor cartridge as defined by claim 4 wherein said at least one shaving aid outlet includes a plurality of shaving aid outlets each defined at least in part by a surface that also at least in part defines said channel.

6. A razor cartridge as defined by claim 1 wherein said first and second razor blade assemblies are movable relative to said housing between a neutral and a retracted position.

7. A razor cartridge as defined by claim 1 further comprising at least one comfort strip coupled to said housing.

8. A razor cartridge as defined by claim 7 wherein said at least one comfort strip includes a first comfort strip coupled to said housing adjacent said first blade assembly, and a second comfort strip coupled to said housing adjacent said second blade assembly.

9. A razor cartridge as defined by claim 1 wherein said housing defines at least one drainage channel.

10. A razor cartridge as defined by claim 9 wherein said housing defines a plurality of drainage channels.

11. A razor cartridge as defined by claim 10 wherein a first portion of said plurality of drainage channels are positioned adjacent to said first razor blade assembly and a second portion of said plurality of drainage channels is positioned adjacent to said second razor blade assembly.

12. A razor cartridge as defined by claim 1 wherein:
said first razor blade assembly includes at least one first pair of razor blades positioned therein, each of said first razor blades having an at least partially exposed cutting edge, and said second razor blade assembly includes at least one second pair of razor blades positioned therein each of said second pair of razor blades having an at least partially exposed cutting edge; and wherein
said cutting edges of said at least one first pair of razor blades are positioned opposite and facing toward said cutting edges of said at least one second pair of razor blades so that during a shaving operation, the razor cartridge can cut hair when drawn over a user's skin in either of two generally opposite directions.

13. A razor cartridge as defined by claim 1 wherein:
said first razor blade assembly includes at least one first pair of razor blades positioned therein, each of said first razor blades having an at least partially exposed cutting edge, and said second razor blade assembly includes at least one second pair of razor blades positioned therein each of said second pair of razor blades having an at least partially exposed cutting edge; and wherein
said cutting edges of said at least one first pair of razor blades are positioned opposite and facing away from said cutting edges of said at least one second pair of razor blades so that during a shaving operation, the razor cartridge can cut hair when drawn over a user's skin in either of two generally opposite directions.
